(19) United States
(12) Patent Application Publication
(10) Pub. No.: US 2014/0144857 A1
(43) Pub. Date: May 29, 2014

(54) Fitting of furniture or the like

(71) Applicants: Dietmar Baro, Berlin (DE); Reiner Kreyenkamp, Bad Essen (DE); Frank Martling, Bad Essen (DE)

(72) Inventors: Dietmar Baro, Berlin (DE); Reiner Kreyenkamp, Bad Essen (DE); Frank Martling, Bad Essen (DE)

(73) Assignee: KESSEBÖHMER HOLDING E.K., Bad Essen (DE)

(21) Appl. No.: 13/880,065

(22) PCT Filed: Oct. 4, 2011
(86) PCT No.: PCT/EP11/04922

§ 371 Date: May 19, 2013

(30) Foreign Application Priority Data
Oct. 18, 2010 (DE) 20 2010 014 343.8

(51) Int. Cl. A47B 81/00; F16C 11/04

(52) U.S. Cl. CPC A47B 81/00; F16C 11/04
USPC 211/150; 403/119

(57) ABSTRACT

The invention relates to a fitting 4 for furniture or the like, in particular for cabinets, for example kitchen corner cabinets 1, for pivotably retaining articles, for example shelves 5, which can be supported in a pivotable manner on a holder 6, for example on a load-bearing column, via a connector 8, wherein the connector 8 has at least one connector arm 8.1, 8.2, which forms an open bearing bushing and is intended for gripping around certain regions of the holder 6, and the connector 8 has a gap 8.3, via which the holder 6 can be introduced into an interior of the arm 8.1, 8.2 of the connector in order to mount the connector 8 on the holder 6.

The invention concerns a fitting for furniture or the like, in particular for cabinets such as kitchen corner cabinets. In addition, the fitting is also suitable to be used on rotary columns and swivel columns of, for example, room dividers, coat racks, or similar objects. In particular, the fitting serves for pivotably supporting objects, for example, shelves, in e.g. kitchen corner cabinets, that are pivotably supportable on a holder, for example, on a support column, by a connector.

Fittings of the aforementioned kind, for example, those that serve for pivotably securing shelves in kitchen corner cabinets are disclosed in EP 1 949 817 B1. They have tubular connectors that are to be mounted on the tube of a support column before installation in a kitchen corner cabinet. The support column, together with the connector and the support arms connected thereto, is then to be inserted into the kitchen corner cabinet. When the support column is to be provided with additional connectors, for example, in order to be able to provide additional shelves, this is possible only after demounting the support column and the corresponding connectors and shelves connected thereto.

It is the object of the present invention to provide a fitting for furniture or similar objects that enables, if possible, to attach without tools, connectors on holders even when they are already installed in a piece of furniture.

For solving this object, the fitting of the aforementioned kind is characterized in that the connector has at least one connector arm that forms an open bearing bushing for gripping about a section of the holder and in that on the connector a gap is formed by means of which the holder can be inserted into an interior of the arm of the connector for mounting the connector on the holder.

In this way, a fitting is provided that can be secured without tools on the holder, for example, a vertically oriented support column in a kitchen corner cabinet in that, for example, after appropriate slanted positioning, first the connector is made to approach the holder such that the connector can be threaded through the gap and, subsequently, the connector is made to approach the holder such that the connector with its arm is supported on the holder, for example, the vertically oriented support column. Accordingly, the connector also forms an open bearing bushing. Holder and the arm have expediently a round shape or are approximately shaped to a round shape so that the inner areas of the arms form the aforementioned bearing bushing of the connector on the holder and form the bearing locations by means of which the connector can be supported pivotably on the holder. The connector can be formed monolithically with a further support arm in order to hold or support, for example, a shelf or the like. The fitting is therefore a universally usable part and cannot only be used in connection with furniture but also, for example, on vertical columns that are positioned free-standing in a room, for example, a room divider.

With the fitting according to the invention, it is also possible, for example, to remove with a few manipulations an object, secured by means of the connector, from the holder and to exchange it for another object in accordance with the holder, for example. Also, it is possible, for example, when only cleaning of the object is desired, to release the object together with the connector from the holder and to connect it again thereat after having performed the appropriate cleaning work. All this is possible without tools.

Preferably, the connector is to be supported on a fastener element that has a top collar and a bottom collar on which upon vertical mounting of the holder the connector can be supported at the top and at the bottom. This fastening element can be adjustably secured on the holder, as is also provided in a further embodiment of the invention. For this purpose, in a simple configuration the holder can be provided with an appropriate row of holes in which a pin or a similar connecting element can lock in order to ensure a height-adjustable securing action of the fastening element on the holder.

Further advantageous embodiments result from the additional dependent claims, the following description, and the drawing. The drawing shows in:

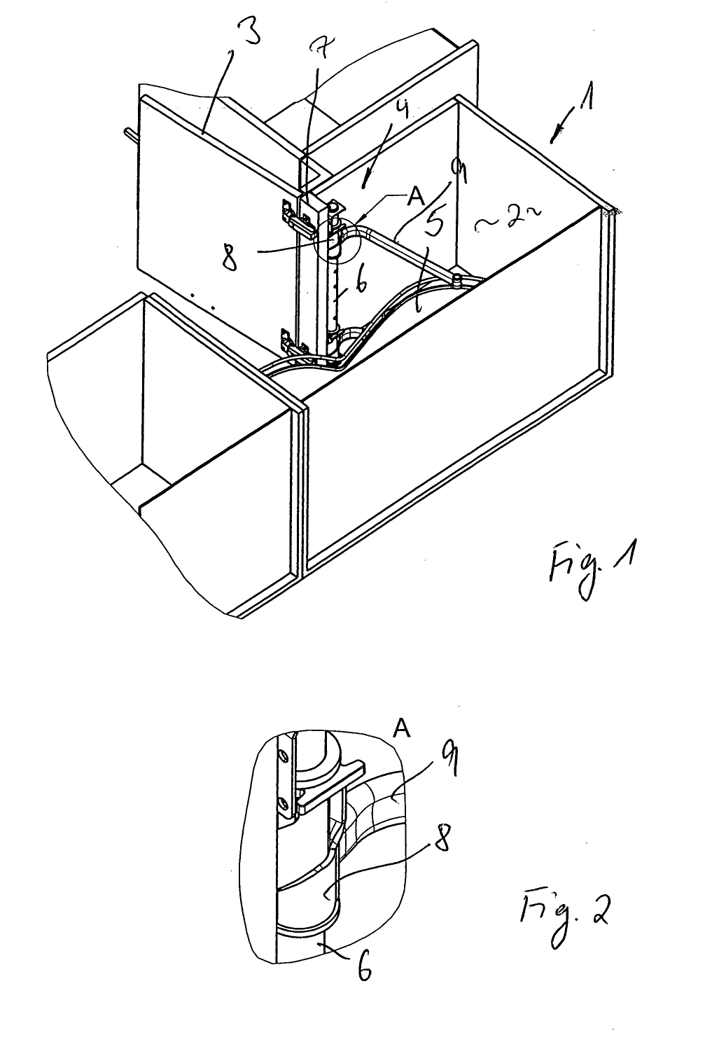

FIG. 1 an embodiment of a fitting according to the invention in the mounted state, showing as an example a perspectively illustrated kitchen corner cabinet;

FIG. 2 an enlarged detail “A” of FIG. 1;

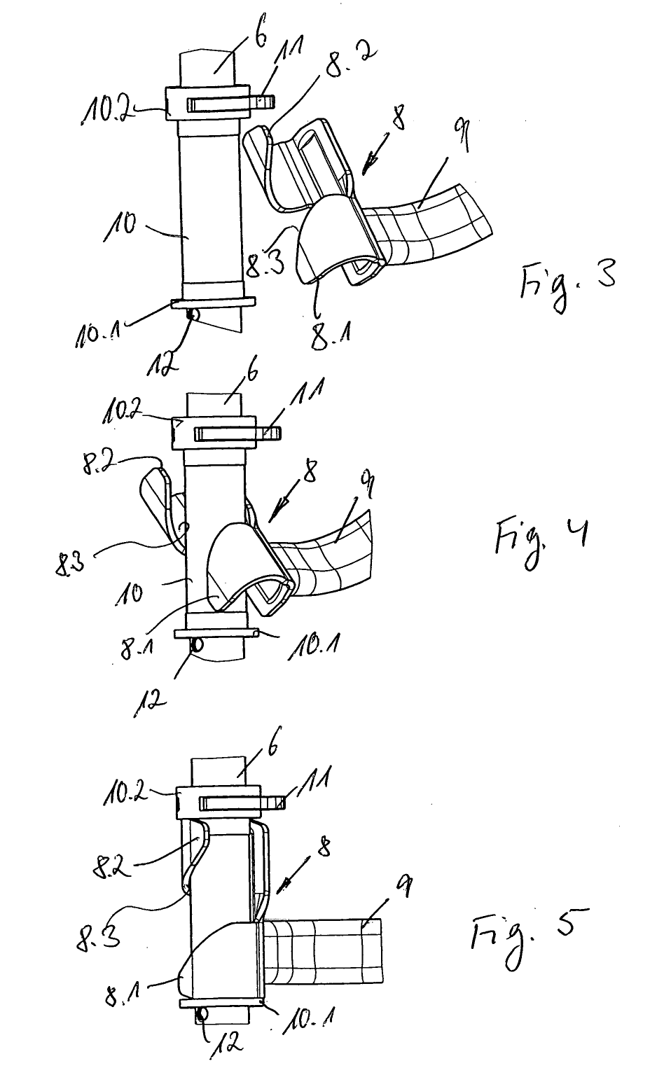

FIG. 3 to FIG. 5 the holder and the connector during mounting of the connector on the holder;

FIG. 6 in a perspective illustration an alternative embodiment of a connector;

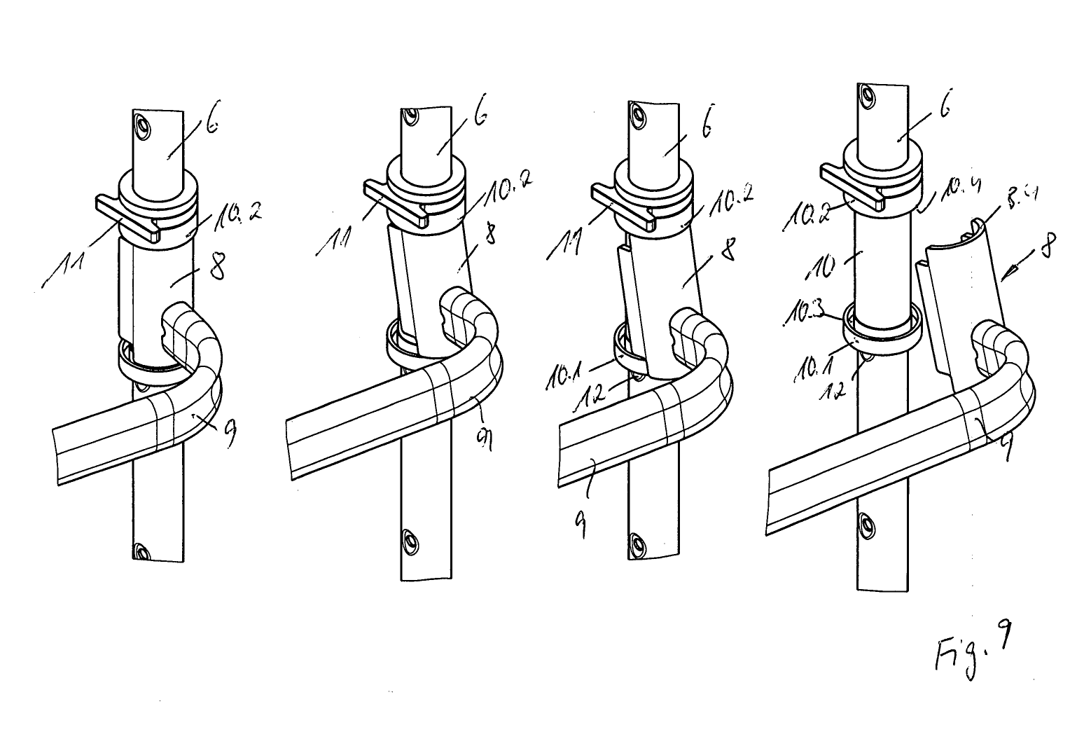

FIG. 7 the embodiment illustrated in Fig. in a mounted position of the connector on the support column;

FIG. 8 a view of a sectioned support tube with a fastening element arranged thereat;

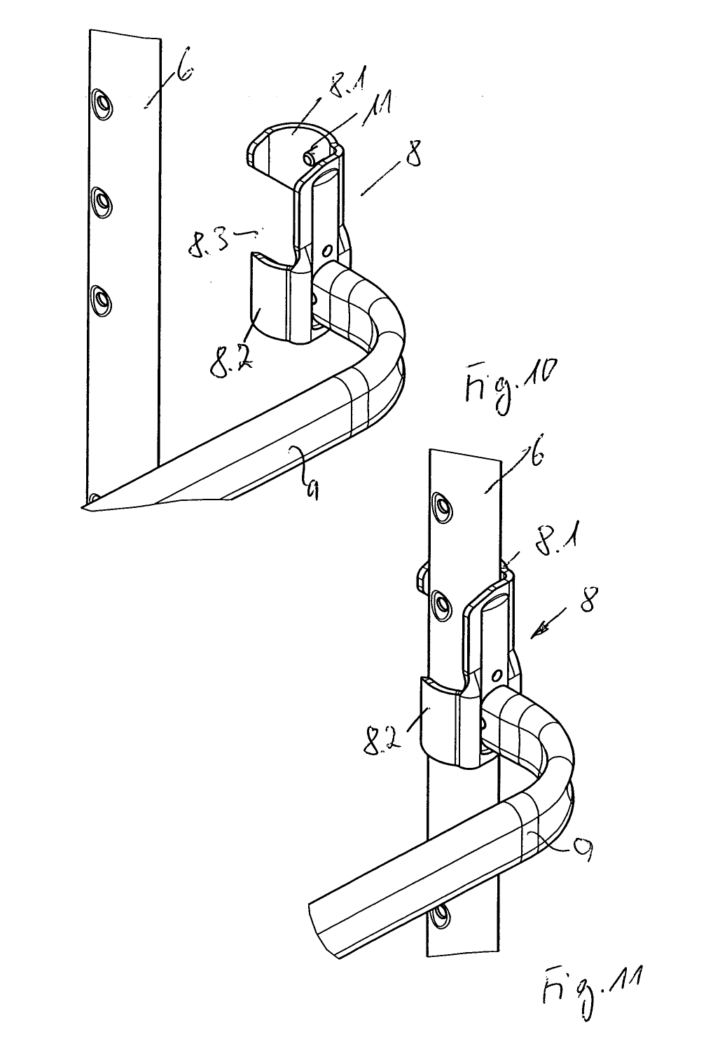

FIG. 9 illustration of mounting of the embodiment according to FIGS. 6 and 7 in different mounting positions;

FIG. 10 a further alternative embodiment of a connector;

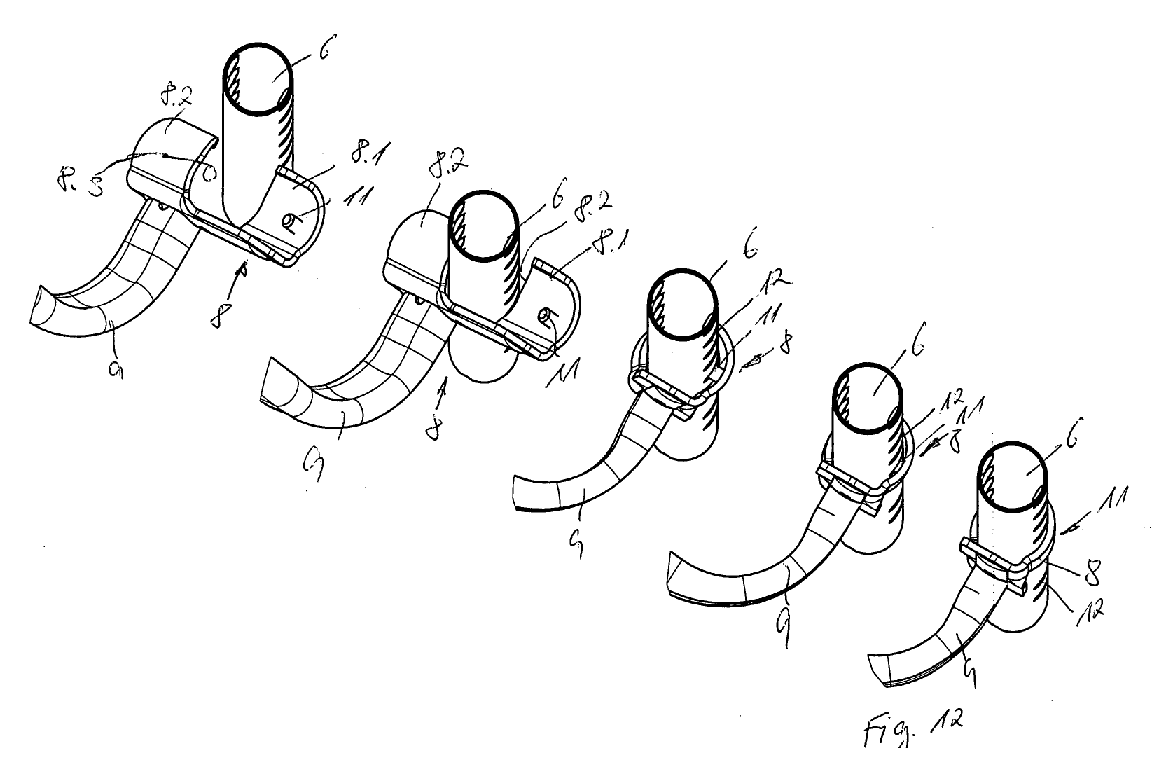

FIG. 11 the embodiment illustrated in FIG. 10 in the mounted position on the support column;

FIG. 12 the various mounting positions during mounting of the embodiment according to FIGS. 10 to 11.

In the embodiment according to FIGS. 6 and 7, the connector 8 is embodied in a semi-shell configuration and has an upper and a lower edge projection 8.4, 8.5 which are provided in appropriate receiving spaces 10.3 and 10.4 on the fastening element. FIG. 9 illustrates, beginning with the mounting position to the right through the two middle illustration to the mounting position to the left, how the connector 8 is to be mounted without tools and, in the final mounted position, is supported safely on the vertical support column 6 as well as on the parts 10.1 and 10.3 and 10.4. In FIGS. 10, 11 and 12, a further alternative embodiment of a connector is shown. This connector 8 has two oppositely oriented arms 8.1 and 8.2. Moreover, a locking projection 11 is provided directly on the arm 8.1 and is to be moved into an appropriate hole in the vertical support column. For this purpose, the gap 8.3 is provided through which the vertical support column 6 can be threaded, as is illustrated in detail in the illustrations of FIG. 12. In the final mounted position according to FIG. 11, the locking projection is inserted into an appropriate hole in the vertical support column 6 so that in this way the connector 8 with the arm 9 is safely secured.

In the drawing, parts that principally act the same are identified with coinciding reference numerals. In general, 1 identifies a kitchen corner cabinet that has an interior 2 that is accessible by a pivotable door 3. This kitchen corner cabinet with the fitting, generally identified by 4, and the shelf 5 that is secured by the fitting is to be designed as disclosed in EP 1 949 817 B1 with regard to the principal movement of the shelf 5 or the shelves 5.

As a holder 6, the fitting 4 comprises a vertically oriented support column which is screwed onto the wall 7 of the kitchen corner cabinet 1 adjacent to the door 3. On the support column 6, support arms 9 for the shelf 5 are secured by means of the connector 8. As disclosed in detail in FIGS. 3 to 5, the connector 8 for the support arm 9 has two oppositely oriented arms 8.1 and 8.2 that between them form a gap 8.3. The terminal areas of the support arms 8.1 and 8.2 overlap each other with a vertical spacing. The vertical spacing is determined by the slot 8.3. Otherwise, the oppositely oriented support arms 8.1 and 8.2, with regard to their contour, follow the fastening element 10 secured on the support column 6 that has a bottom collar 10.1 and a top collar 10.2. On this fastening element 10, in the area of the collar 10.2, a clip 11 is fastened which supports a locking element, not shown in detail, and can lock in appropriate holes 12 for vertical adjustment on the support column 6.

In FIG. 3 the state of the connector 8 prior to mounting on the holder or the support column 6 is illustrated. The connector 8 together with the support arm is illustrated in a slightly slanted or tilted position so that the support column 6 with its fastening element 10 can be inserted or threaded into the gap 8.3.

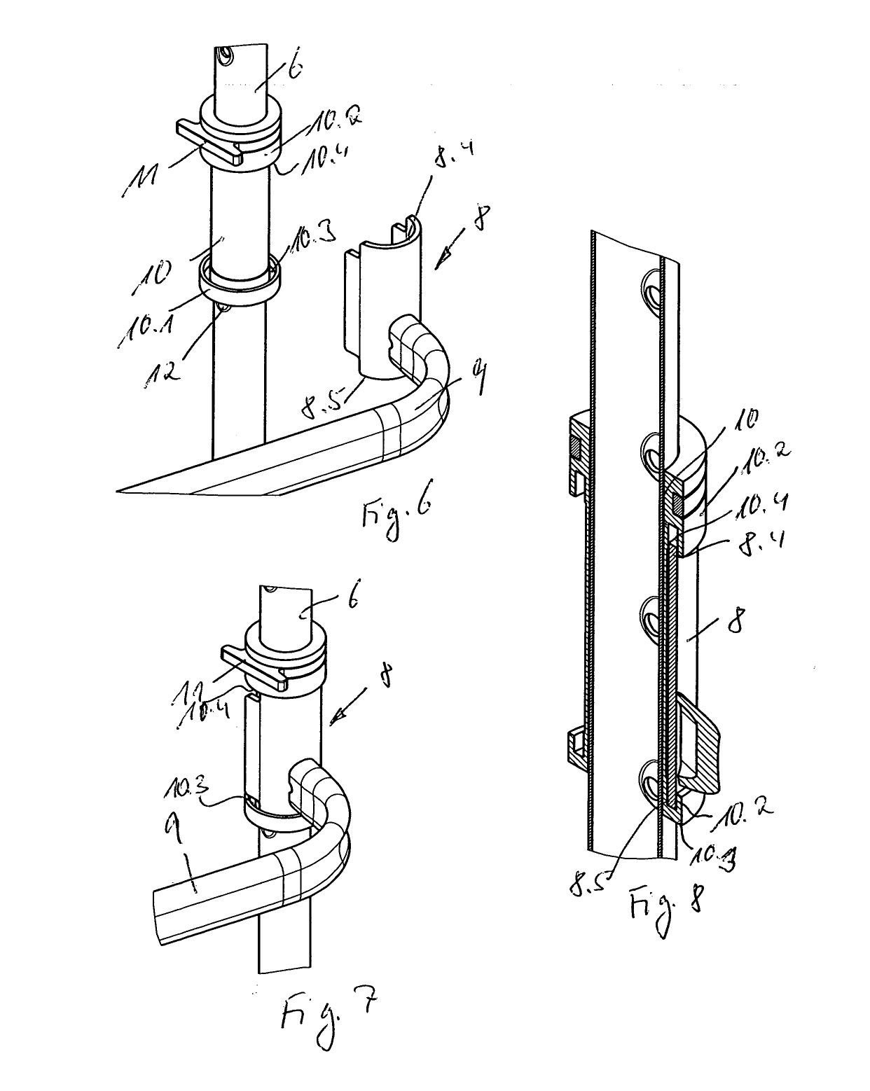

FIG. 4 illustrates a further movement during mounting in that therein the fastening element 10 or the holder 6 is inserted into the gap 8.3 so that, by means of a tilting or pivot movement, it can be brought back into the mounted end position as illustrated in FIG. 5. It is apparent that all this can be done without tools.

In the reverse sequence the connector can be demounted from the support column 6. In the mounted state, the connector is supported with the inner surfaces of the oppositely oriented arms 8.1 and 8.2 on the fastening element 10 or the support column. In upward and downward directions, it is delimited by the collars 10.1 and 10.2 and is therefore also supported appropriately thereat.

What is claimed is:

1-14. (canceled)

15. A fitting for a piece of furniture for pivotably supporting objects on a holder, the fitting comprising:
a connector comprising a connector arm forming an open bearing bushing for gripping about a section of a holder, wherein the connector arm has an interior;
a gap formed on the connector;
wherein the gap is adapted to enable insertion of the holder into the interior of the connector arm of the connector for mounting the connector on the holder.

16. The fitting according to claim 15, wherein the connector has two of said connector arm, wherein the two connector arms are oppositely oriented relative to each other and wherein the gap is formed between the two connector arms, wherein the interior is formed by the space between the two connector arms.

17. The fitting according to claim 16, wherein the two connector arms have terminal areas that overlap each other at a vertical spacing relative to each other.

18. The fitting according to claim 17, wherein the gap formed between the two connector arms has a slanted orientation and the two connector arms have neighboring edges that are facing each other, wherein the neighboring edges are provided with slantedly formed areas, wherein the terminal areas of the arms decrease toward ends thereof.

19. The fitting according to claim 15, wherein the holder is provided with a top collar and a bottom collar and wherein a topside and a bottom side of the connector is supported in a mounted state thereof at the top collar and the bottom collar.

20. The fitting according to claim 15, wherein the connector is adapted to be mounted on the holder without tools.

21. The fitting according to claim 15, further comprising a fastening element that is secured on the holder so as to be adjustable vertically on the holder, wherein the connector is supported on the holder by the fastening element.

22. The fitting according to claim 21, wherein the fastening element has a top collar and a bottom collar.

23. The fitting according to claim 15, wherein the connector is comprised of a metallic material.

24. The fitting according to claim 15, wherein the holder is provided with a row of bores determining different vertical positions for the connector, wherein the connector is adapted to be secured on the holder in any of the different vertical positions by a height-adjusting element insertable into one of the bores.

25. The fitting according to claim 15, wherein the connector has two of said connector arm, wherein the two connector arms are oppositely oriented relative to each other and wherein on one of the two connector arms a locking element is provided that is inserted into a bore provided in the holder and secures the connector to the holder.

26. The fitting according to claim 15, wherein the connector arm is substantially of a semi-shell configuration and is secured on an abutment provided on the holder.

27. The fitting according to claim 26, further comprising a fastening element that is secured on the holder and has at least one receiving space for receiving and supporting the connector arm.

28. The fitting according to claim 27, wherein the fastening element is embodied as a height adjuster.

29. The fitting according to claim 15, wherein the piece of furniture is a kitchen corner cabinet and wherein the holder is a support column mounted in an interior of the kitchen corner cabinet, wherein the objects are pivotable shelves.
